(19) United States
(12) Patent Application Publication
(10) Pub. No.: US 2026/0029385 A1
(43) Pub. Date: Jan. 29, 2026

(54) QUANTIFYING METHOD

(71) Applicant: SHIN-ETSU CHEMICAL CO., LTD., Tokyo (JP)

(72) Inventors: Kazuomi SATO, Joetsu-shi (JP); Hitoshi HIRAHARA, Joetsu-shi (JP)

(73) Assignee: SHIN-ETSU CHEMICAL CO.,LTD., Tokyo (JP)

(21) Appl. No.: 19/277,909

(22) Filed: Jul. 23, 2025

(30) Foreign Application Priority Data
Jul. 24, 2024 (JP) 2024-118392

(51) Int. Cl. G01N 30/86; G01N 30/02

(52) U.S. Cl. CPC G01N 30/8675; G01N 2030/027

(57) ABSTRACT

The present invention is a quantifying method by which a sample containing an analyte is quantified for the analyte, the method including steps of: (1) measuring the same sample a plurality of times by using a measurement apparatus to obtain a plurality of quantitative values of the analyte in the sample; and (2) calculating an amount of change in the analyte derived from the measurement apparatus from the plurality of the quantitative values, and correcting at least one of the plurality of the quantitative values with the amount of change to obtain a true quantitative value of the analyte. This provides a method for more accurately quantifying an analyte in a measurement system in which an amount of the analyte increases or decreases in a measurement apparatus during measurement of the sample.

### TECHNICAL FIELD

The present invention relates to a quantifying method in a measurement system in which a quantitative value of an analyte originally present in a sample cannot be obtained because an amount of the analyte increases or decreases in the measurement system during measurement of the sample.

### BACKGROUND ART

Considered as an example is such an extremely hydrolysable substance that when the sample is in contact with a cell, piping, etc. in a measurement system during measurement, the substance is hydrolyzed upon contact with water adsorbed on the inner wall.

It is inevitable that such a substance contains a hydrolyzed product as an impurity because of its property. When this hydrolyzed product is an analyte, introducing a sample into a measurement apparatus for measurement generates the analyte by water adsorbed on an inner wall of piping or a vessel. The analyte generated as above becomes background, and an obtained quantitative value of the analyte becomes larger than an amount of the analyte originally present in the sample.

To correctly quantify such an analyte, the water adsorbed on the inner wall of the measurement apparatus is removed completely or to the extent that the water does not affect the quantification to prevent generation of the background.

Although depending on design of the measurement apparatus, it is considered that a member constituting the majority of the measurement system including the piping, etc. is metal with considering pressure resistance and heat resistance. Literature describes that water adsorbed on metal is eliminated from the surface by heating the member at 120° C. to 150° C. (see Non Patent Documents 1 and 2, for example). However, it is extremely difficult to confirm that the water is completely removed or reduced to the extent that water does not affect the quantification. In addition, heating the member has a risk of mechanical change of the measurement system such as, for example, deviation of an optical axis to affect the quantification result. Therefore, it is unrealistic that the water adsorbed on the inner wall of the measurement apparatus is removed completely or to the extent that the water does not affect the quantification to prevent generation of the background.

Meanwhile, a method of reducing the background during the measurement is devised. For example, Patent Documents 1 and 2 describe a method of reducing a substance that is present around a light source and a detector and that causes the background, in spectroscopy of gas. This method has a premise that an analyte and the substance causing the background are present in separated spaces. In the object of the present invention, however, the analyte and the background are present in the same space, and thus, reducing a signal derived from the background by this method simultaneously reduces a signal derived from the analyte to fail to result in the quantification.

Patent Document 3 proposes, in spectroscopy of gas, a method of reducing a signal derived from the background by pressurizing gas being an analyte in order to reduce the background during measurement. This method also requires that the analyte and the background are present in separated spaces. When the analyte and the background are present in the same space, reducing the signal derived from the background also reduces a signal derived from the analyte to fail to result in the quantification. In addition, this method is limited to the case of gas, which limits the application range.

### CITATION LIST

### Patent Literature

Patent Document 1: JP H9-005233 A
Patent Document 2: JP 2011-179942 A
Patent Document 3: JP 4715759 B

### Non Patent Literature

Non Patent Document 1: Journal of the Vacuum Society of Japan, 2010, Vol. 53, p 527.
Non Patent Document 2: Vacuum and Surface Science, 2018, Vol. 61, p 27.

### SUMMARY OF INVENTION

### Technical Problem

As above, when the extremely hydrolysable analyte is quantified, the sample has to be measured in a state where water is adsorbed on the inner wall of piping, a vessel, etc. of a measurement apparatus contacted with the sample during the measurement. In this case, when how much of the background is generated, namely an amount of change in the analyte, can be determined, the analyte originally contained in the sample can be quantified by correcting the obtained quantitative value with the amount of change. However, the amount of change cannot be determined actually, and therefore, the analyte has not been quantified.

In addition, quantification by liquid chromatography has a problem that an analyte to be adsorbed on a filler in a column cannot be quantified correctly. To correctly quantify such an analyte, the adsorption is reduced by surface-treating the filler, etc. and such an approach has been performed by manufactures. However, the adsorption cannot be avoided with some types of the analyte, and fails to result in correct quantification.

An object of the present invention is to solve the above problem and to provide a method for quantifying the analyte more accurately in the measurement system in which an amount of the analyte increases or decreases in the measurement apparatus during measurement of the sample.

### Solution to Problem

To solve the above problem, the present invention provides a quantifying method by which a sample containing an analyte is quantified for the analyte, the method including steps of:
(1) measuring the same sample a plurality of times by using a measurement apparatus to obtain a plurality of quantitative values of the analyte in the sample; and
(2) calculating an amount of change in the analyte derived from the measurement apparatus from the plurality of the quantitative values, and correcting at least one of the plurality of the quantitative values with the amount of change to obtain a true quantitative value of the analyte.

The method as above can quantify the analyte more accurately in the measurement system in which the amount of the analyte increases or decreases in the measurement apparatus during the measurement of the sample.

The analyte in the sample may be measured by using one measurement apparatus.

Alternatively, the analyte in the sample may be measured by using a plurality of measurement apparatuses.

In the quantifying method of the present invention, the number of the measurement apparatuses is not limited to one, and may be plural.

In addition, the analyte in the sample may be measured by using a plurality of measurement apparatuses having the same specification.

Alternatively, the analyte in the sample may be measured by using a plurality of measurement apparatuses with different specifications.

When a plurality of the measurement apparatuses are used in the quantifying method of the present invention, specifications of the apparatuses may be same as or different from each other.

In addition, the analyte in the sample may be measured by using a gas cell.

Alternately, the analyte in the sample may be measured by using a liquid cell.

In the quantifying method of the present invention, the sample form is not particularly limited.

The step (1) may be performed by chromatography selected from a liquid chromatograph, an ion chromatograph, and a gas chromatograph using a plurality of columns.

In this case, the plurality of the columns may be connected in series or in parallel for use.

The quantifying method of the present invention can be applied for quantitative analysis using the chromatography, for example.

### Advantageous Effects of Invention

The present invention enables to quantify the analyte more accurately in the measurement system in which the analyte is modified in the measurement apparatus during the measurement of the sample or in which the analyte is adsorbed on a filler in column chromatography.

### BRIEF DESCRIPTION OF DRAWINGS

FIG. 1 is a view illustrating one example of the quantifying method of the present invention in which the same cell is used in the first and second measurements;

FIG. 2 is a view illustrating one example of the quantifying method of the present invention in which different cells are used in the first and second measurements;

FIG. 3 is a view illustrating one example of the quantifying method of the present invention in which two gas cells are connected in series;

FIG. 4 is a view illustrating one process example of the quantifying method of the present invention in which measurement is performed by infrared spectroscopy using a gas cell;

FIG. 5 is a view illustrating one example of the quantifying method of the present invention in which three or more gas cells are connected in series;

FIG. 6 is a view illustrating one example of the quantifying method of the present invention in liquid chromatography in which two columns having the same length are connected in series, and a detector is connected on a downstream side of each of the columns;

FIG. 7 is a view illustrating one example of the quantifying method of the present invention in liquid chromatography in which two columns having different lengths are connected in series, and a detector is connected on a downstream side of each of the columns;

FIG. 8 is a view illustrating one example of the quantifying method of the present invention in liquid chromatography in which two columns having different lengths are connected in parallel, and a detector is connected on a downstream side of each of the columns; and

FIG. 9 is a view illustrating one example of the quantifying method of the present invention in liquid chromatography in which two columns having different lengths are connected in parallel, and connected to one detector via a six-port valve.

### DESCRIPTION OF EMBODIMENTS

As noted above, there has been a demand for development of a method for quantifying an analyte more accurately in a measurement system in which an amount of the analyte increases or decreases in a measurement apparatus during measurement of a sample.

The present inventors have made earnest study to achieve the above object, and devised a quantifying method in which an amount of change in an analyte is calculated from a difference in a plurality of quantitative values obtained by measuring the same sample a plurality of times, and the quantitative value is corrected with this amount of change to obtain a true quantitative value.

Specifically, the present invention is a quantifying method by which a sample containing an analyte is quantified for the analyte, the method including steps of:
(1) measuring the same sample a plurality of times by using a measurement apparatus to obtain a plurality of quantitative values of the analyte in the sample; and
(2) calculating an amount of change in the analyte derived from the measurement apparatus from the plurality of the quantitative values, and correcting at least one of the plurality of the quantitative values with the amount of change to obtain a true quantitative value of the analyte.

Hereinafter, embodiments of the present invention will be described with reference to the drawings, but the present invention is not limited thereto.

### First Aspect

In the first aspect of the quantifying method of the present invention, an analyte in a sample is measured by using one measurement apparatus. This aspect can be applied for any cases of a liquid cell and a gas cell.

### Preliminary Experiment

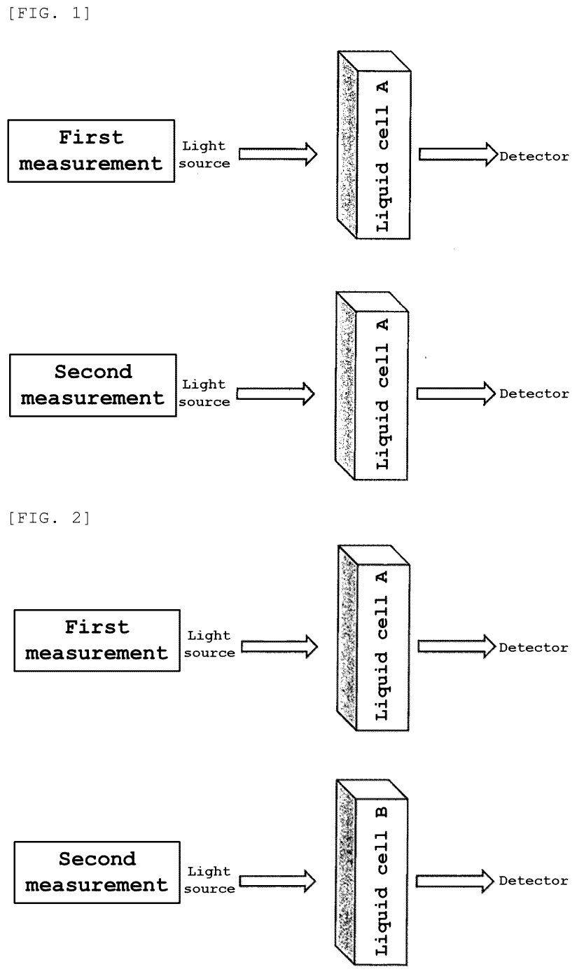

FIG. 1 is a view illustrating an example of measuring a liquid sample by using one liquid cell. The same liquid cell A is used in the first and second measurements, and amounts of change in the analyte need to be the same in the first measurement and the second measurement. To achieve that, the same washing or pretreatment as washing or pretreatment for the cell A before the first measurement needs to be performed before the second measurement. It also needs to check the reproducibility of the measurement after the washing or the pretreatment.

### Step (1)

After the preliminary experiment as above, the sample is measured with the cell A to obtain a quantitative value A1 of the analyte in the sample. Then, the measured sample is taken out once, and the cell A is washed or pretreated. Thereafter, the measured sample is added again into the cell A, and measured to obtain a quantitative value A2 of the analyte in the sample. Note that, as an instrument used for taking out the measured sample, an instrument with a fluororesin or with a deactivation-treated inner surface is used, for example, to prevent modification of the sample.

### Step (2)

Then, the amount of change in the analyte derived from the measurement apparatus (the cell A) is calculated as follows from the plurality of the quantitative values (the quantitative values A1 and A2), and the quantitative value A1 and/or A2 is corrected with the calculated amount of change to obtain the true quantitative value of the analyte.

In this time, the first quantitative value A1 is expressed by:

$$The quantitative value A 1 = The amount of the analyte originally present in the sample + The amount of change \qquad Expression ( 17 )$$

Since the amount of change in the analyte is the same in the first measurement and the second measurement, the second quantitative value A2 is expressed by:

$$The quantitative value A 2 = The quantitative value A 1 + The amount of change = The amount of the analyte originally present in the sample + The amount of change + The amount of change = The amount of the analyte originally present in the sample + The amount of change + 2 \times The amount of change \qquad Expression ( 18 )$$

The expression (17) is subtracted from the expression (18), and the left side and the right side are replaced to be:

$$The amount of change = The quantitative value A 2 - The quantitative value A 1 \qquad Expression ( 19 )$$

The expression (17) is manipulated to be:

$$The amount of the analyte originally present in the sample = The quantitative value A 1 - The amount of change \qquad Expression ( 20 )$$

The expression (19) is substituted into the right side to be:

$$The amount of the analyte originally present in the sample = The quantitative value A 1 - ( The quantitative value A 2 - The quantitative value A 1 - The quantitative value A 1 ) = 2 \times The quantitative value A 1 - The quantitative value A 2$$

to determine the amount of the analyte originally present in the sample.

The first aspect of the present invention can be expressed as follows, for example.

A quantifying method by which a sample containing an analyte is quantified for the analyte, the method including steps of:
(1) adding the sample into a measurement apparatus A, and obtaining a quantitative value A1 of the analyte in the sample by using the measurement apparatus A;
(2) adding the sample subjected to the step (1) again into the measurement apparatus A, and obtaining a quantitative value A2 of the analyte in the sample by using the measurement apparatus A; and
(3) determining a difference between the quantitative value A1 and the quantitative value A2, defining the difference as an amount of change A in the analyte derived from the measurement apparatus A, and correcting the quantitative value A1 and/or the quantitative value A2 with the amount of change A to obtain a true quantitative value of the analyte.

### Second Aspect

In the second aspect of the quantifying method of the present invention, an analyte in a sample is measured by using a plurality of measurement apparatuses having different specifications. This aspect can be applied for any cases of a liquid cell and a gas cell.

### Step (1)

FIG. 2 is a view illustrating an example of measuring a liquid sample by using two liquid cells A and B. In contrast to FIG. 1, the liquid cell A is used in the first measurement, and the liquid cell B is used in the second measurement. As an instrument used for recovering the sample, an instrument with a fluororesin or with a deactivation-treated inner surface is used, for example, to prevent modification of the sample during the recovery, which is the same as in FIG. 1. It is also acceptable that two spectrometers are used, and a liquid cell 1 is measured with one spectrometer and a liquid cell 2 is measured with the other spectrometer.

For example, with two measurement apparatuses, each of liquid cells or gas cells as the cells A and B, the sample is firstly measured with the cell A to obtain a quantitative value 1A, and this measured sample is measured with the cell B to obtain a quantitative value 1B. In this time, an amount of change in the analyte generated with the cell A is defined as an amount of change A, and an amount of change in the analyte generated with the cell B is defined as an amount of change B. Separately to this procedure, the sample is firstly measured with the cell B to obtain a quantitative value 2B, and this measured sample is measured with the cell A to obtain a quantitative value 2A. In this time, an amount of change in the analyte generated with the cell A is defined as an amount of change A, and an amount of change in the analyte generated with the cell B is defined as an amount of change B. In this case, of course, it needs to wash or pretreat each of the cells A and B in order to equalize the amounts of change in the analyte in the first measurement and the second measurement.

### Step (2)

Then, the amounts of change A and B in the analyte derived from the measurement apparatuses are calculated as follows from the plurality of the quantitative values (the quantitative values 1A, 1B, 2B, and 2A), and each of the quantitative values is corrected with the calculated amounts of change to obtain a true quantitative value of the analyte.

When a case where the measurements are performed in an order of A and B is expressed as (A->B) and a case where the measurement are performed in an order of B and A is expressed as (B->A),

$$The quantitative value A ( A - > B ) = The amount of the analyte originally present in the sample + The amount of change A \qquad Expression ( 1 )$$

The expression (1) is manipulated to be:

$$The amount of the analyte originally present in the sample = The quantitative value A ( A - > B ) - The amount of change A \qquad Expression ( 2 )$$

$$The quantitative value B ( A - > B ) = The quantitative value A ( A - > B ) + The amount of change B \qquad Expression ( 3 )$$

The expression (3) is manipulated to be:

$$The amount of change B = The quantitative value B ( A - > B ) - The quantitative value A ( A - > B ) \qquad Expression ( 4 )$$

Thus, the amount of change B is determined from the measurement result in the order of A and B.

Meanwhile, when the measurements are performed in the order of B and A,

$$The quantitative value B ( B - > A ) = The amount of the analyte originally present in the sample + The amount of change B \qquad Expression ( 5 )$$

The expression 5 is manipulated to be:

$$The amount of the analyte originally present in the sample = The quantitative value B ( B - > A ) - The amount of change B \qquad Expression ( 6 )$$

Into this expression, the amount of change B determined by the expression (4) can be substituted to determine the amount of the analyte originally present in the sample.

Further,

$$The quantitative value A ( B - > A ) = The quantitative value B ( B - > A ) + The amount of change A \qquad Expression ( 7 )$$

The expression (7) is manipulated to be:

$$The amount of change A = The quantitative value A ( B - > A ) = The quantitative value B ( B - > A ) \qquad Expression ( 8 )$$

The obtained amount of change A can also be substituted into the expression (2) to determine the amount of the analyte originally present in the sample.

The amount of the analyte originally present in the sample can be obtained as the two values in the expression (2) and the expression (6), and thus, these values can be compared to check reliability of the quantitative values. When the analyte is not modified in the measurement apparatus during the measurement, all the quantitative value A (A->B), the quantitative value B (A->B), the quantitative value A (B->A), and the quantitative value B (B->A) are the equal values, and the amount of change A and the amount of change B are 0.

The second aspect of the present invention can be expressed as follows, for example.

A quantifying method by which a sample containing an analyte is quantified for the analyte, the method including steps of:

(1A) adding the sample into a measurement apparatus A, and obtaining a quantitative value 1A of the analyte in the sample by using the measurement apparatus A;

(1B) adding the sample subjected to the step (1A) into a measurement apparatus B, and obtaining a quantitative value 1B of the analyte in the sample by using the measurement apparatus B;

(2B) newly adding the sample into the measurement apparatus B, separately to the sample subjected to the steps (1A) and (1B), and obtaining a quantitative value 2B of the analyte in the sample by using the measurement apparatus B; and

(3) determining a difference between the quantitative value 1A and the quantitative value 1B, defining the difference as an amount of change B of the analyte derived from the measurement apparatus B, and correcting the quantitative value 2B with the amount of change B to obtain a true quantitative value of the analyte.

The quantifying method preferably includes, after the step (2B), a step (2A) of adding the sample subjected to the step (2B) into the measurement apparatus A, and obtaining a quantitative value 2A of the analyte in the sample by using the measurement apparatus A.

In this case, preferably performed together with the step (3) is a step (3′) of determining a difference between the quantitative value 2B and the quantitative value 2A, defining the difference as an amount of change A of the analyte derived from the measurement apparatus A, and correcting the quantitative value 1A with the amount of change A to obtain the true quantitative value of the analyte.

### Third Aspect

The third aspect of the quantifying method of the present invention is a quantifying method in a case where the amounts of change obtained by measuring the same sample a plurality of times are known to be equal in the first measurement and the second and subsequent measurements (for example, a case where the analyte in the sample is measured by using a plurality of measurement apparatuses having the same specification). This aspect can be applied for any cases of a liquid cell and a gas cell.

### Step (1)

When the amounts of change obtained by measuring the same sample a plurality of times are known to be equal in the first measurement and the second and subsequent measurements by a preliminary experiment (for example, when a measurement apparatus A and a measurement apparatus B have the same specification, and an amount of change derived from the measurement apparatus A and an amount of change derived from the measurement apparatus B are equal), the amount of the analyte originally present in the sample can be determined by one set of measurements (only A->B or B->A) without replacing the measurement order as the order of A and B and the order of B and A as in the second aspect.

First, the sample is quantitatively measured to obtain a quantitative value 1 of the analyte. In this time, the analyte increases or decreases in the measurement system to generate a certain amount of change 1. Therefore, this quantitative value 1 is a difference between an amount of the analyte originally present in the sample and an amount of change 1 being an amount of a modified analyte in the measurement apparatus. When an amount of change where the analyte increases is a positive value,

$$The quantitative value 1 = The amount of the analyte originally present in the sample + The amount of change 1 \qquad ( Expression ( 9 )$$

The expression (9) is manipulated to be:

$$The analyte originally present in the sample = The quantitative value 1 - The amount of change 1 \qquad Expression ( 10 )$$

The quantitative value 1 has been obtained, and thus, it is clear that the analyte originally present in the sample can be quantified by determining the amount of change 1.

Then, the sample subjected to the first quantifying measurement is taken out of the test system, and measured again under the same condition to obtain a quantitative value 2. This same condition is a condition such that, as noted above, the amounts of change obtained by measuring the same sample a plurality of times are known to be equal in the first measurement and the second and subsequent measurements (for example, a condition such that the amount of change derived from the measurement apparatus A and the amount of change derived from the measurement apparatus B are equal). This quantitative value 2 is an amount in which an amount of change 2 being an amount of change in the analyte in the measurement apparatus during the second measurement is added to an amount of the analyte present in the sample after the first measurement, namely the quantitative value 1.

### Step (2)

Specifically,

$$The quantitative value 2 = The quantitative value 1 + The amount of change 2 \qquad Expression ( 11 )$$

Here, since the amount of change 2 in the second measurement and the amount of change 1 in the first measurement are equal,

$$The amount of change 2 = The amount of change 1 \qquad Expression ( 12 )$$

This expression is substituted into the expression (11) to be:

$$The quantitative value 2 = The quantitative value 1 + The amount of change 1 \qquad Expression ( 13 )$$

The expression (9) is substituted into the quantitative value 1 in the expression (13) to be:

$$The quantitative value 2 = The amount of the analyte originally present in the sample + The amount of change 1 \qquad Expression ( 14 )$$

The expression (9) is subtracted from the expression (14) to be:

$$The quantitative value 2 = The quantitative value 1 + The amount of change 1 \qquad Expression ( 15 )$$

From the quantitative values measured twice, the amount of change 1 can be calculated. The right side and the left side in the expression (15) are replaced to be:

$$The amount of change 1 = The quantitative value 2 - The quantitative value 1 \qquad Expression ( 16 )$$

This expression is substituted into the expression (10) to be:

$$The analyte originally present in the sample = The quantitative value 1 - ( The quantitative value 2 - The quantitative value 1 ) = The quantitative value 1 - The quantitative value 2 + The quantitative value 1 = 2 \times The quantitative value 2 - The quantitative value 2$$

Since the quantitative values 1 and 2 have been obtained as the measurement data, the amount of the analyte originally present in the sample can be quantified. When the analyte is not modified in the measurement apparatus during the measurement, the amount of change 1 and the amount of change 2 are 0, and the quantitative value 1 and the quantitative value 2 are the equal value.

The third aspect of the present invention can be expressed as follows, for example.

A quantifying method by which a sample containing an analyte is quantified for the analyte, the method including steps of:
(1) adding the sample into a measurement apparatus A, and obtaining a quantitative value A of the analyte in the sample by using the measurement apparatus A;
(2) adding the sample subjected to the step (1) into a measurement apparatus B having the same specification as of the measurement apparatus A, and obtaining a quantitative value B of the analyte in the sample by using the measurement apparatus B; and
(3) determining a difference between the quantitative value A and the quantitative value B, defining the difference as an amount of change in the analyte derived from each of the measurement apparatuses A and B, and correcting the quantitative value A and/or the quantitative value B with the amount of change to obtain a true quantitative value of the analyte.

In the cases of FIGS. 1 and 2, as an instrument for treating the sample for the first measurement and an instrument for recovering the sample after the first measurement, for example, instruments with a fluororesin or with a deactivation-treated inner surface are used so that the sample is not modified during treatment and recovery of the sample, thereby avoiding modification of the analyte in these steps. If the modification cannot be avoided, however, it may be considered that, in the first measurement, the quantitative value including the amounts of change in all the steps from the treatment of the sample to the first measurement has been measured and, in the second measurement, the quantitative value including the amounts of change in the recovery of the sample after the first measurement and before the second measurement has been measured. In this case, it is needed that the instrument used for treating the sample in the first measurement and the instrument used for recovering the sample after the first measurement are the same instrument to set the amounts of change in these steps to be equal. In addition, reproducibility of the quantitative values including the recovering operation needs to be checked.

### Fourth Aspect

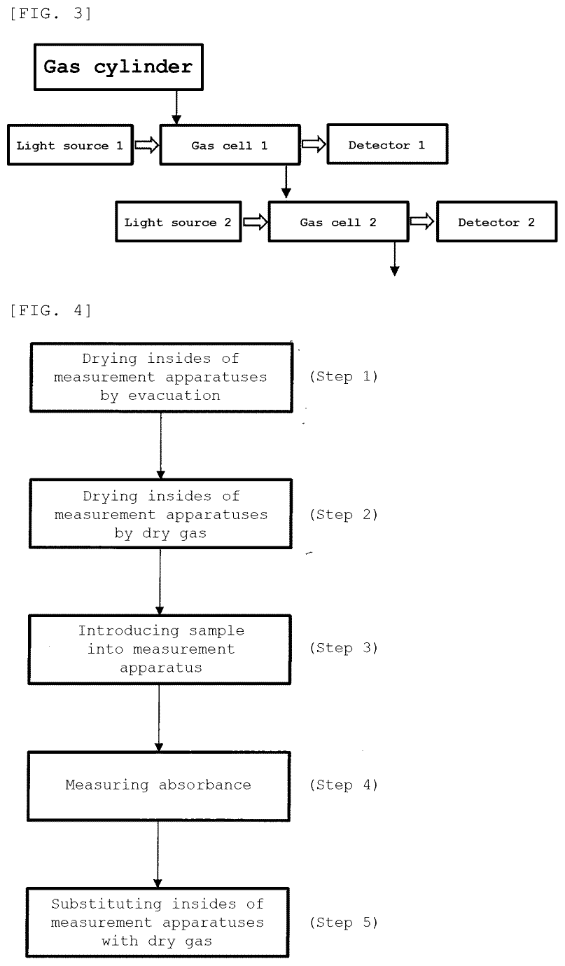

In the quantifying method of the present invention, the measurement can also be performed by spectroscopy as illustrated in FIG. 3 with connecting two spectrometers using a gas cell in series.

For example, two infrared spectrometers using a gas cell are connected in series as in FIG. 3, and hydrogen chloride (the analyte) in dichlorosilane (the sample) is quantified by the procedure illustrated in FIG. 4. As illustrated in FIG. 4, the quantifying method of the present invention includes: drying insides of measurement apparatuses by evacuation (step 1); drying the insides of the measurement apparatuses with dry gas (step 2); introducing a sample into the measurement apparatus (step 3); measuring absorbance (step 4); and substituting the insides of the measurement apparatuses with dry gas (step 5). Hereinafter, each step will be described in detail.

### Step 1: Drying Insides of Measurement Apparatuses by Evacuation

A vacuum pump is prepared and connected to the measurement apparatus to evacuate the insides. For example, while heating piping, a mass-flow controller, and a valve at 40° C., evacuation may be performed until the degree of vacuum reaches-90 kPa (G).

### Step 2: Drying Insides of Measurement Apparatuses with Dry Gas

For example, dry nitrogen gas (Grade 3, dew point: −70° C., H₂O concentration: 2.55 ppm) filled in a gas cylinder is introduced inside the measurement apparatuses at a pressure of 200 kPa and a flow rate of 4 to 5 L/min to dry the insides of the measurement apparatuses overnight (about 10 hours).

### Step 3: Introducing Sample into Measurement Apparatus

The dichlorosilane gas is introduced into the measurement apparatus. For example, the dichlorosilane gas is introduced inside the measurement apparatus at a pressure of 50 to 100 kPa and 2 to 3 L/min.

### Step 4: Measuring Absorbance

Absorbance of hydrogen chloride in the dichlorosilane gas filled in the gas cylinder is measured. For example, a peak at 2981 cm⁻¹ derived from a stretching vibration mode of H—Cl in hydrogen chloride being the analysis target is not overlapped with infrared absorption peaks of dichlorosilane and present in the valley thereof. Thus, it is considered that hydrogen chloride can be quantified without an effect by dichlorosilane, but the peak is not limited thereto. The absorbance of the peak of hydrogen chloride is continuously measured from immediately after the introduction of the sample, and when the absorbance becomes a stable and constant value, this value is used for the quantification.

### Step 5: Substituting Insides of Measurement Apparatuses with Dry Gas

When the measurement is finished, the dichlorosilane gas is removed from the measurement apparatuses. For example, evacuation is performed until the degree of vacuum reaches-90 kPa (G), and then dry nitrogen gas is introduced inside the measurement apparatuses at a pressure of 200 kPa and a flow rate of 4 to 5 L/min to substitute the insides of the measurement apparatuses with the dry nitrogen gas. Absorbance of a peak of dichlorosilane (near 2237 cm⁻¹) is continuously measured from immediately after the introduction of the dry nitrogen gas, and the substitution is continued until this peak is not detected.

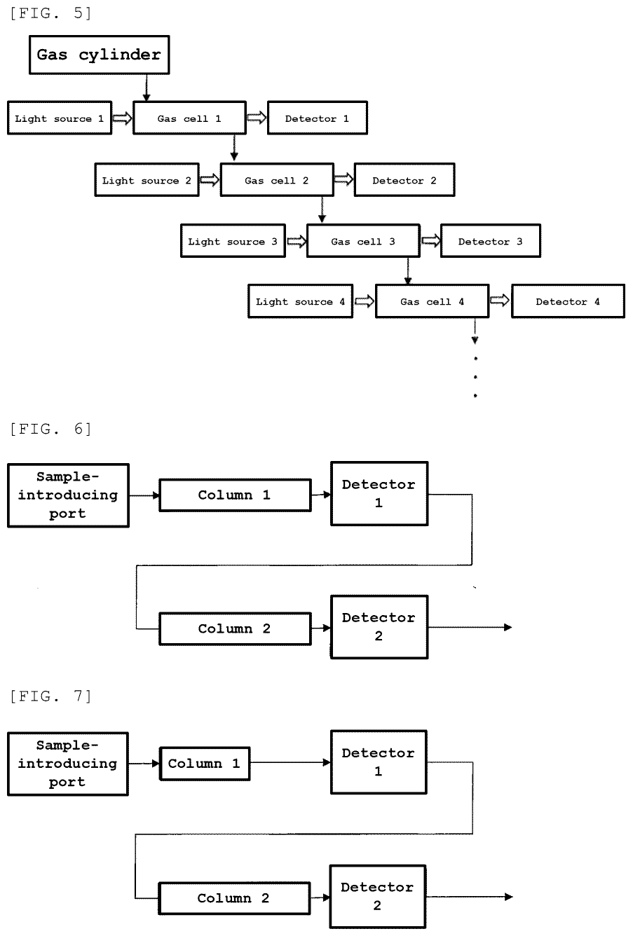

Note that, in this case, three or more infrared spectrometers using a gas cell may be connected in series as in FIG. 5. From a quantitative value obtained with an infrared spectrometer, a quantitative value obtained with the immediately upstream infrared spectrometer is subtracted to determine an amount of change, and the quantitative value is corrected with the amount of change, which is the same manner as in the case of two spectrometers.

### Fifth Aspect

FIG. 6 is a view illustrating an example in liquid chromatography of connecting two columns with the same diameter, length, and filler in series and connecting a detector on a downstream side of each of the columns. A quantitative value obtained with the detector 1 is subtracted from a quantitative value obtained with the detector 2 to determine an amount of change, and the quantitative value is corrected with the amount of change, which is the same manner as in the aforementioned example. Note that, a differential refractometry (RI) detector for liquid chromatography typically has low pressure resistance. When such a detector is used in the present application, the pressure resistance needs to be checked. Since the diameter, length, and filler are the same, amounts of change in the analyte generated in passing through the two columns are considered to be ideally equal, but it is desirably confirmed before the measurement that the amounts of change be equal. For this purpose, the columns are each singly connected, and the quantitative values are determined. When the quantitative values are different in this case, it is found that the amounts of change in the analyte are different, and the quantitative value can be obtained by measurement with reversing the order of the two columns, which is the same as above.

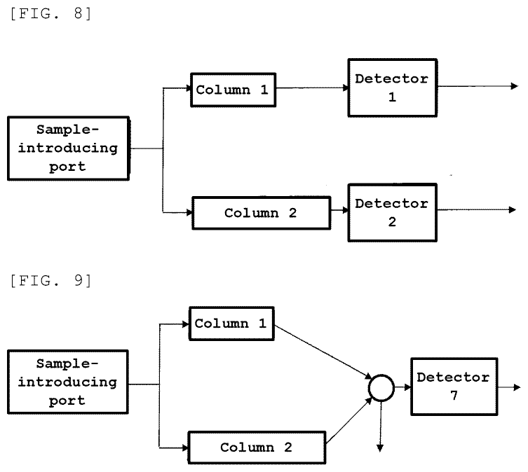

FIG. 7 is a view illustrating an example in liquid chromatography of connecting two columns with the same diameter and filler but different lengths in series and connecting a detector on a downstream side of each of the columns. In this case, the difference is only the length, and amounts of change in the analyte generated in passing through each of the columns are considered to be ideally proportional to the length, but it is desirably confirmed before the measurement that the amounts of change be proportional. Also, the columns are each singly connected, and the quantitative values are determined.

FIG. 8 is a view illustrating an example in liquid chromatography of connecting two columns with the same diameter and filler but different lengths in parallel and connecting a detector on a downstream side of each of the columns. In this case, back pressure is not applied to the detector, and thus, there is no concern about the aforementioned pressure resistance when using the RI detector. The difference is only the length, and amounts of change in the analyte generated in passing through each of the columns are considered to be ideally proportional to the length, but it is desirably confirmed before the measurement that the amounts of change be proportional. Also, the columns are each singly connected, and the quantitative values are determined. When the columns are connected in parallel, it is acceptable that two columns having different lengths are connected in parallel and connected to one detector via a six-port valve, as in FIG. 9.

In the present invention, the step (1) may be performed by chromatography selected from a liquid chromatograph, an ion chromatograph, and a gas chromatograph using a plurality of columns. In this case, the plurality of the columns may be connected in series or in parallel for use.

### Example

Hereinafter, the present invention will be more specifically described with showing Example and Comparative Example of the present invention, but the present invention is not limited thereto.

### Example

Two of the same infrared spectrometers were prepared, and defined as apparatuses A and B. To remove moisture adsorbed on an inner wall of the apparatus and piping in the apparatus A, dry nitrogen (dew point: −70° C., water content: 2.55 ppm) was passed for one minute while heating each piping at 40° C., and then, evacuation was performed for 10 minutes. This cycle purge was repeated 30 times. It took about 5 hours for the degree of vacuum to reach-90 kPa (G) or higher. Then, standard gases (nitrogen containing hydrogen chloride at 0.1, 0.2, 0.5, 1.0, and 5.0 ppm) were introduced and measured without breaking the vacuum to prepare a calibration curve. Thereafter, dichlorosilane gas was introduced without breaking the vacuum to measure a peak of hydrogen chloride over time, and when the measurement value became stable, hydrogen chloride was quantified by using the calibration curve. The same procedure was also performed with the apparatus B to quantify hydrogen chloride, and it was confirmed that the equal quantitative value was obtained with the apparatuses A and B.

Then, the apparatuses A and B were connected in series in this order. To remove moisture adsorbed on the inner wall of the apparatuses and piping, dry nitrogen (dew point: −70° C., water content: 2.55 ppm) was passed for one minute while heating each piping at 40° C., and then, evacuation was performed for 10 minutes. This cycle purge was repeated 30 times. It took about 5 hours for the degree of vacuum to reach-90 kPa (G) or higher. Then, standard gases (nitrogen containing hydrogen chloride at 0.1, 0.2, 0.5, 1.0, and 5.0 ppm) were introduced and measured without breaking the vacuum to prepare a calibration curve with each of the apparatuses A and B. Thereafter, dichlorosilane gas was introduced without breaking the vacuum to measure a peak of hydrogen chloride over time, and when the measurement value became stable, hydrogen chloride was quantified by using the calibration curve. Table 1 shows the results (Test Numbers 1 to 11) of quantifying hydrogen chloride while changing the lots. The amounts of hydrogen chloride varied from 0.026 ppm to 1.083 ppm in the lots, but a value of the apparatus B—the apparatus A, namely an amount of hydrogen chloride generated in the system of the apparatus B (an amount of change) during the measurement was approximately constant.

TABLE 1

| | Qantification value of | | | |
|---|---|---|---|---|
| | hydrogen chloride (ppm) | | | |
| Test | | | Apparatus B − | Amount of hydrogen chloride |
| Number | Apparatus A | Apparatus B | Apparatus A | in dichlorosilane (ppm) |
| 1 | 1.756 | 2.429 | 0.673 | 1.083 |
| 2 | 0.626 | 1.121 | 0.496 | 0.130 |
| 3 | 1.047 | 1.460 | 0.413 | 0.634 |
| 4 | 0.647 | 1.051 | 0.403 | 0.244 |
| 5 | 0.602 | 1.152 | 0.549 | 0.053 |
| 6 | 1.243 | 1.743 | 0.500 | 0.743 |
| 7 | 0.895 | 1.355 | 0.460 | 0.435 |
| 8 | 0.488 | 0.949 | 0.461 | 0.026 |
| 9 | 0.685 | 1.141 | 0.456 | 0.230 |
| 10 | 0.500 | 0.921 | 0.421 | 0.079 |
| 11 | 0.989 | 1.514 | 0.525 | 0.463 |

Then, the apparatuses B and A were connected in series in this order, and the quantification was performed while changing the lots in the same manner as in the above. Table 2 shows the results (Test Numbers 12 to 13). The amounts of hydrogen chloride varied from 0.463 ppm to 0.815 ppm in the lots, but a value of the apparatus A—the apparatus B, namely an amount of hydrogen chloride generated in the system of the apparatus A (an amount of change) during the measurement was approximately constant and was approximately equal to the value in the case of connecting the apparatuses A and B in this order. It was confirmed that the order of the apparatuses did not affect the value.

TABLE 2

| | Qantification value of | | | |
|---|---|---|---|---|
| | hydrogen chloride (ppm) | | | |
| Test | | | Apparatus A − | Amount of hydrogen chloride |
| Number | Apparatus B | Apparatus A | Apparatus B | in dichlorosilane (ppm) |
| 12 | 1.375 | 1.935 | 0.560 | 0.815 |
| 13 | 0.989 | 1.514 | 0.525 | 0.463 |

As above, the quantifying method of the present invention can yield the amount of change in the analyte with good reproducibility, and therefore, a true quantitative value (a more accurate quantitative value) can be obtained by correcting the quantitative value using this amount of change.

### Comparative Example

When the two infrared spectrometers were connected in series in the above Example, the measurement results with the upstream apparatus A can be regarded as the same measurement as by a conventional method. Thus, the data were used as Comparative Example. The measurement procedure and the obtained results were the same as in Example, but an amount of hydrogen chloride generated in the system of the apparatus A during the measurement was unknown, and thus, the quantitative value of hydrogen chloride itself quantified with the apparatus A had to be adopted as the quantitative value of hydrogen chloride in dichlorosilane. The amounts of hydrogen chloride in dichlorosilane obtained in Comparative Example were as in Table 3, which were larger than the values obtained in Table 1 and overestimated. The amount of hydrogen chloride generated in the system of the apparatus A cannot be quantified in Comparative Example, and thus, the amount of hydrogen chloride in dichlorosilane cannot be quantitatively described, and it can be only said that the amount is smaller than or equal to a certain value.

TABLE 3

| Test | Qantification value of | Amount of hydrogen chloride |
|---|---|---|
| Number | hydrogen chloride (ppm) | in dichlorosilane (ppm) |
| 1 | 1.756 | 1.756 or lower |
| 2 | 0.626 | 0.626 or lower |
| 3 | 1.047 | 1.047 or lower |
| 4 | 0.647 | 0.647 or lower |
| 5 | 0.602 | 0.602 or lower |
| 6 | 1.243 | 1.243 or lower |
| 7 | 0.895 | 0.895 or lower |
| 8 | 0.488 | 0.488 or lower |
| 9 | 0.685 | 0.685 or lower |
| 10 | 0.500 | 0.500 or lower |
| 11 | 0.989 | 0.989 or lower |

The present invention is not limited to the above embodiments. For example, the two infrared spectrometers were used in Example, but the light source and the detector may be the same in the first measurement and the second measurement in FIG. 2. That is, the light source in one infrared spectrometer may enter the cells A and B to perform the measurement.

When an analysis result of a specimen (the sample) with an infrared spectrometer is affected by moisture left in the system through which the specimen was passed, a more preferable result can be obtained by further heating the piping used for introducing the specimen and the gas cell and passing highly pure dry nitrogen gas to sufficiently remove moisture adsorbed on the inner wall. If moisture adsorbed on the inner wall can be sufficiently removed by heating the piping used for introducing the dichlorosilane gas and the gas cell at 120° C. to 150° C. or higher and passing highly pure dry nitrogen gas, etc., although it is impossible by the present technology, a blank value can be reduced to lower the quantification lower limit and the detection limit. In heating at a high temperature, the space between the detector and the cell is preferably thermally insulated in order to prevent an effect on the infrared spectrometer being the detector. If a gas cell, piping, and a window member that can resist against higher evacuation can be used, moisture left in the system can be further reduced. Thus, this can also reduce the blank value to enable more accurate measurement, which can yield a more preferable result. This case can also be used for quantifying hydrogen chloride in trichlorosilane or tetrachlorosilane, which has a higher boiling point than dichlorosilane.

The present description includes the following embodiments.
[1] A quantifying method by which a sample containing an analyte is quantified for the analyte, the method comprising steps of: (1) measuring the same sample a plurality of times by using a measurement apparatus to obtain a plurality of quantitative values of the analyte in the sample; and (2) calculating an amount of change in the analyte derived from the measurement apparatus from the plurality of the quantitative values, and correcting at least one of the plurality of the quantitative values with the amount of change to obtain a true quantitative value of the analyte.
[2] The quantifying method according to [1], wherein the analyte in the sample is measured by using one measurement apparatus.
[3] The quantifying method according to [1], wherein the analyte in the sample is measured by using a plurality of measurement apparatuses.
[4] The quantifying method according to [3], wherein the analyte in the sample is measured by using a plurality of measurement apparatuses having the same specification.
[5] The quantifying method according to [3], wherein the analyte in the sample is measured by using a plurality of measurement apparatuses with different specifications.
[6] The quantifying method according to any one of [1] to [5], wherein the analyte in the sample is measured by using a gas cell.
[7] The quantifying method according to any one of [1] to [5], wherein the analyte in the sample is measured by using a liquid cell.
[8] The quantifying method according to any one of [1] to [7], wherein the step (1) is performed by chromatography selected from a liquid chromatograph, an ion chromatograph, and a gas chromatograph using a plurality of columns.
[9] The quantifying method according to [8], wherein the plurality of the columns are connected in series or in parallel for use.

It should be noted that the present invention is not limited to the above-described embodiments. The embodiments are just examples, and any examples that substantially have the same feature and demonstrate the same functions and effects as those in the technical concept disclosed in claims of the present invention are included in the technical scope of the present invention.

1. A quantifying method by which a sample containing an analyte is quantified for the analyte, the method comprising steps of:
(1) measuring the same sample a plurality of times by using a measurement apparatus to obtain a plurality of quantitative values of the analyte in the sample; and
(2) calculating an amount of change in the analyte derived from the measurement apparatus from the plurality of the quantitative values, and correcting at least one of the plurality of the quantitative values with the amount of change to obtain a true quantitative value of the analyte.

2. The quantifying method according to claim 1, wherein the analyte in the sample is measured by using one measurement apparatus.

3. The quantifying method according to claim 1, wherein the analyte in the sample is measured by using a plurality of measurement apparatuses.

4. The quantifying method according to claim 3, wherein the analyte in the sample is measured by using a plurality of measurement apparatuses having the same specification.

5. The quantifying method according to claim 3, wherein the analyte in the sample is measured by using a plurality of measurement apparatuses with different specifications.

6. The quantifying method according to claim 1, wherein the analyte in the sample is measured by using a gas cell.

7. The quantifying method according to claim 1, wherein the analyte in the sample is measured by using a liquid cell.

8. The quantifying method according to claim 1, wherein the step (1) is performed by chromatography selected from a liquid chromatograph, an ion chromatograph, and a gas chromatograph using a plurality of columns.

9. The quantifying method according to claim 8, wherein the plurality of the columns are connected in series or in parallel for use.
